(19) United States
(12) Patent Application Publication
(10) Pub. No.: US 2009/0237509 A1
(43) Pub. Date: Sep. 24, 2009

(54) MOTION ACTIVATED CAMERA SYSTEM

(75) Inventor: Donald Conrad Saxon, Bay Springs, MS (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: VibraShine, Inc., Taylorsville, MS (US)

(21) Appl. No.: 12/408,343

(22) Filed: Mar. 20, 2009

Related U.S. Application Data
(60) Provisional application No. 61/038,618, filed on Mar. 21, 2008.

(51) Int. Cl. H04N 7/18

(52) U.S. Cl. 348/155; 348/E07.085

(57) ABSTRACT

The present invention provides a motion activated camera system having first and second housings. The first housing includes a motion detector, an illuminator, a transmitter, and a first power supply. The first power supply supplies power to the motion detector, the illuminator, and the transmitter. The motion detector provides a field of coverage for detecting motion. The second housing comprising a camera, a receiver, and a second power supply supplying power to the camera and the receiver. The transmitter transmits a signal to the receiver to instruct the camera to record an image when the motion detector detects apparent motion within the field of coverage. The present invention also includes a method of using a motion activated camera.

### CROSS REFERENCE TO RELATED APPLICATION

This application claims the benefit of U.S. Provisional Patent Appln. No. 61/038,618 filed on Mar. 21, 2008, which is incorporated by reference as if fully set forth.

### BACKGROUND

Motion activated cameras are frequently used for surveillance purposes, often as part of a security system or for use in activities such as hunting and tracking. These systems enable a user to capture photographs or video of a given location without requiring the continuous presence of an individual. Typically, these systems consist of a camera, a motion detection device, an illumination source, and a power supply contained within a single housing. Because the illumination device and motion sensor are located in the housing with the camera, the positioning options of these systems are limited, as these components must be located in close proximity to the targeted area. In addition to being large, heavy, and difficult to carry and conceal in the field, these units are often targeted by thieves, as their automated nature lends themselves to being left unattended for extended periods of time. The risk of theft is further increased as a result of the placement of the camera and the illumination device in the same housing, as the flash or glow from the illumination device, indicating lights, or LEDs, reveals the position of the entire unit during operation.

The motion detectors incorporated into known camera systems typically monitor or project one or more “detection zones” of varying dimensions and configurations in order to provide coverage over a desired area. However, because the detector is normally firmly secured within a housing, the orientation of the detection zones is fixed relative to the orientation of the housing. Such an arrangement results in limited mounting options for the detector and limited detection zones. If the housing is mounted outside of a preferred mounting position, the coverage of the detection zones may be compromised, such as by a reduction in the detection range and/or a reduction in overall coverage area. For example, a detector may lose its effectiveness unless mounted at a specified height, as the mounting height of the detector may dictate the height of the detection zones. This is a critical factor when attempting to track smaller targets, such as game.

Accordingly, there remains a need for a motion activated camera system that is more easily hidden from the view of both game and would-be thieves, while offering expanded positioning options and range of detection zones.

### SUMMARY

A first aspect of the present invention provides a motion detecting camera system having a first housing comprising a motion detector, an illuminator, a transmitter, and a first power supply supplying power to the motion detector, the illuminator, and the transmitter. The motion detector is connected to the transmitter and provides a field of coverage for detecting motion. A second housing comprises a camera, a receiver connected thereto, and a second power supply supplying power to the camera and the receiver. The transmitter transmits a signal to the receiver to instruct the camera to record an image when the motion detector detects motion within the field of coverage.

In another aspect of the present invention, a method for using a motion detecting camera system is provided. The method includes providing a first housing comprising a motion detector, an illuminator, a transmitter, and a first power supply supplying power to the motion detector, the illuminator, and the transmitter. The motion detector is connected to the transmitter and illuminator, and provides a field of coverage for detecting motion. A second housing is provided and comprises a camera, a receiver connected thereto, and a second power supply supplying power to the camera and the receiver. A signal is transmitted from the transmitter to the receiver to instruct the camera to record an image when the motion detector detects motion within the field of coverage.

### BRIEF DESCRIPTION OF THE DRAWINGS

The foregoing summary, as well as the following detailed description of the preferred embodiments of the invention will be better understood when read in conjunction with the appended drawings. For the purpose of illustrating the invention, there are shown in the drawings embodiments which are presently preferred. It should be understood, however, that the invention is not limited to the precise arrangements shown.

FIG. 1 is a perspective view of an embodiment of a first housing of the present invention containing a motion detector and an illumination device.

FIG. 2 is a front view of an embodiment of a second housing of the present invention containing a camera.

FIG. 3 is a bottom view of an embodiment of the second housing of the present invention in a partially-opened state.

FIG. 4 is a rear view of an embodiment of the second housing of the present invention.

FIG. 5 is a front view of an alternate embodiment of the first housing of the present invention containing a motion detector and an illumination device.

FIG. 6 is a side view of an embodiment of the first housing of the present invention showing the motion detector and illumination device movably mounted to a base portion.

FIG. 7 is a block diagram of an embodiment of the present invention illustrating the communication between the components of the two housings.

FIG. 8 is a block diagram of an alternate embodiment of the present invention illustrating the communication between the components of the two housings and optionally, communication between the second housing and a base station.

FIG. 9 is a top view of an embodiment of the present invention showing the first housing mounted to an object and the motion detector arranged to have a substantially horizontal detection zone.

FIG. 10 is a side view of the embodiment of FIG. 9.

FIG. 11 is a top view of an embodiment of the present invention showing the first housing mounted to an object and the motion detector arranged to have a substantially vertical orientation.

FIG. 12 is a side view of an embodiment of FIG. 11.

FIG. 13 is a front view of a representative Fresnel lens used in an embodiment of the present invention.

FIG. 14 is a front view of an alternate embodiment of a housing of the present invention containing a camera, an illumination device, and a motion detector with an adjustable lens.

### DETAILED DESCRIPTION OF THE PREFERRED EMBODIMENTS

Certain terminology is used in the following description for convenience only and is not considered limiting. Words such as “front”, “back”, “top” and “bottom” designate directions in the drawings to which reference is made. This terminology includes the words specifically noted above, derivatives thereof and words of similar import. Additionally, the terms “a” and “one” are defined as including one or more of the referenced item unless specifically noted.

Preferred embodiments of the present invention will be described with reference to the drawing figures where like numerals represent like elements throughout.

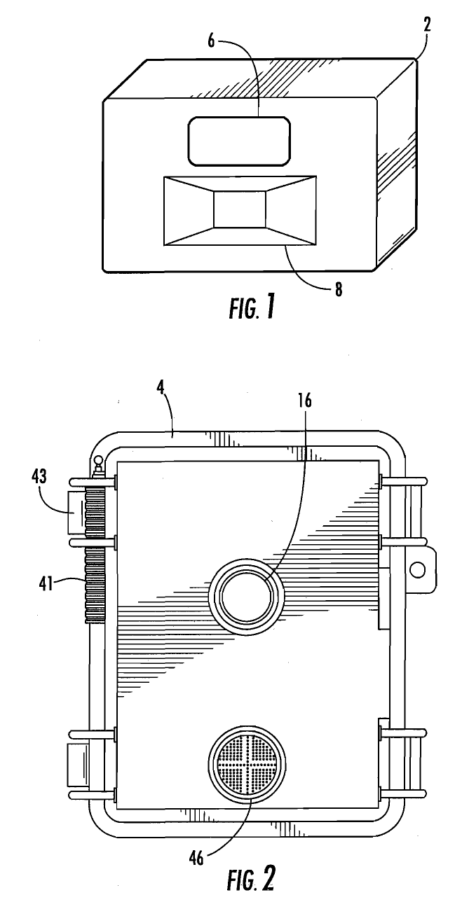

Referring generally to FIGS. 1-4, and 7, a preferred embodiment of the present invention provides a motion activated camera system comprising at least two separate housings 2, 4. The first housing 2 contains a motion detector 6, an illumination device 8, a transmitter 10, and a power supply 12. A second housing 4, separable from the first housing 2, contains a camera 16, a receiver 22 adapted to receive signals from the first housing 2, and a second power supply 20. The second housing 4 may further include a microphone 46 and an antenna 41 to receive signals from the transmitter 10. The first housing 2 may also include an antenna (not shown) for sending signals to the receiver 22. The transmitter 10 preferably sends radio signals to the receiver 22; however, one of ordinary skill in the art would recognize that other types of signals can be sent between the transmitter and receiver without departing from the present invention.

The first and second housings 2, 4 preferably comprise weatherproof containers for protecting and securing the above mentioned components. The housings 2, 4 can be formed from plastic, metal, composites, or any other suitable materials and preferably comprise camouflaged exteriors to further aid concealment in an outdoor environment. Although the housings 2, 4 are normally separated from one another while in use, they also may have the ability to be selectively joined together as a single unit, similar to traditional field camera systems known in the art. As shown in FIG. 3, the housings 2, 4 may comprise two halves connected by at least one hinge 43 which, when opened, reveal a display 60, user controls 62 such as switches, or other associated features in an internal portion thereof. In a preferred embodiment, the user controls 62 include and on/off/test switch as well as controls for operating the camera, display, and other associated hardware or features. The housings 2, 4 may also include input or output connections 63. The connections 63 may be used to connect an auxiliary battery or solar panel, additional illumination devices or motion detectors, or to provide an external location to download data stored by the camera. The user controls 62 and the connections 63 may also be accessible through an external opening 80 in the housing 4. One of ordinary skill in the art will recognize that the user controls can be located in various positions throughout the second housing 4 without departing from the spirit of the invention.

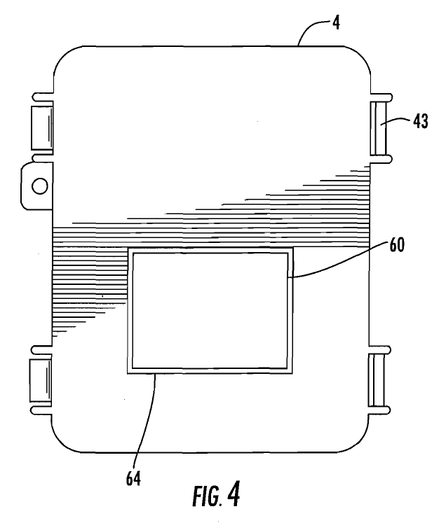

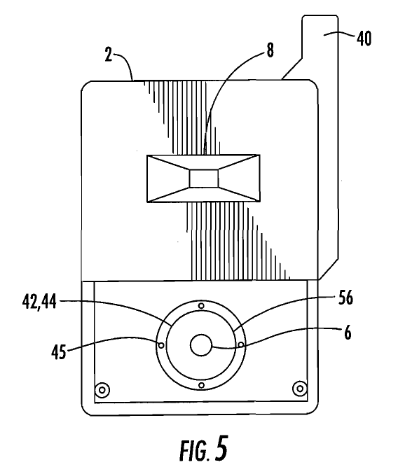

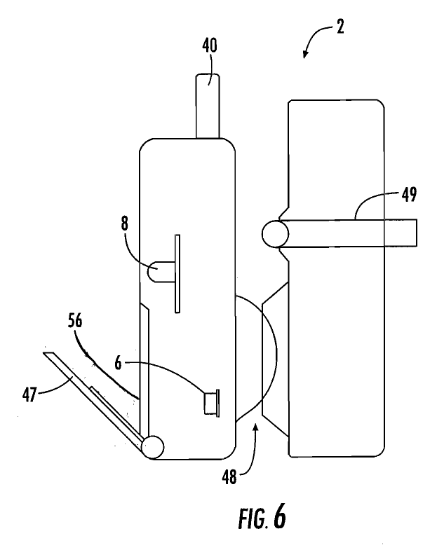

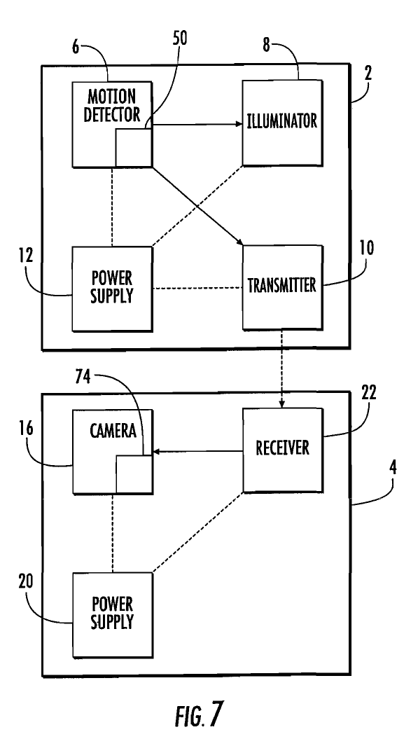

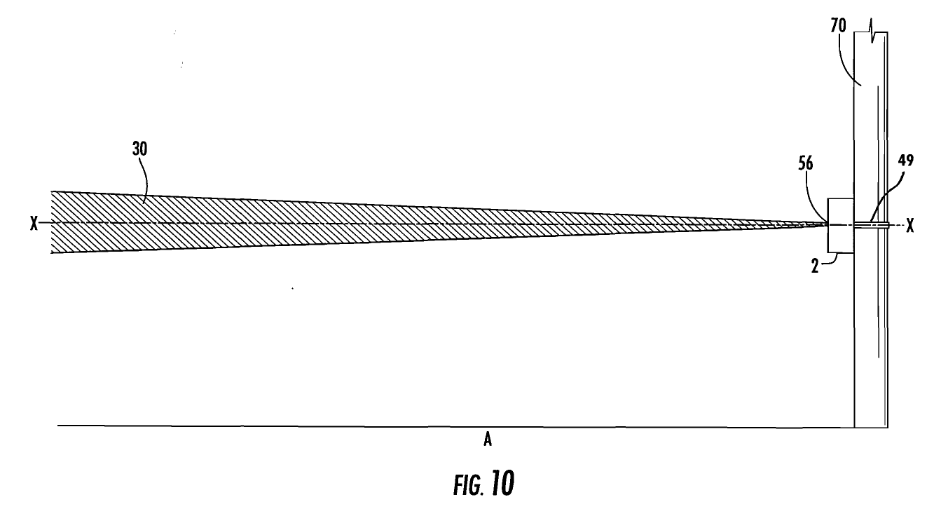

The display 60 is preferably an LCD display, and even more preferably a twisted nematic (TN) display or a thin film transistor (TFT) display, used to aid the operator in adjusting the settings of the device, or to allow the operator to view pictures and/or video in the field. As shown in FIG. 4, the housing 2, 4 may also include a transparent window 64 to permit an operator to view the display 60 without opening the housings 2, 4. A securing device 49 can be used to mount the housings 2, 4 for use in the field. The securing device 49 can be a security bar (as shown in FIG. 6), straps (as shown in FIG. 9-12), or any other suitable type of mounting provisions. The housings 2, 4 can also include attachment points for connection to a stand. One of ordinary skill in the art would recognize that the housings 2, 4 may include any suitable type of mounting provisions.

Preferably, the camera 16 is capable of capturing still images, such as pictures, recording moving images, such as video, and recording sound, and storing such data onto a memory device 74. The memory device 74 preferably comprises a hard drive or a removable memory card, such as a Secure Digital (SD) card, in order to allow a user to easily access, transport and view the data at an alternate location, such as on a home computer. Any suitable memory device may be utilized to store data recorded by the camera 16 without departing from the scope of the present invention. In addition, other types of cameras could be used, such as traditional film cameras or thermographic cameras, without departing from the scope of the present invention.

The illumination device 8 preferably comprises an infrared illuminator, but may also comprise other sources of illumination, such as traditional flash devices. The infrared illuminator may utilize red-glow LEDs, or more preferably, non-glow LEDs in order to further ensure the camera's concealment in the field. A light filter may also be used utilized to control the visible light emitted by the illumination device 8. A daylight sensor could also be incorporated into either housing, controlling the illumination function as needed. Additional illumination devices may be connected to either the first or second housings 2, 4. Preferably, these supplemental illumination devices feature their own power supplies and are activated in unison with the primary illumination device located within the housing 2.

Preferably, the motion detector 6 comprises a passive infrared sensor (PIR) used to detect apparent motion when an infrared source of one temperature passes in front of an infrared source of another temperature. Other types of motion detectors, including infrared, light, ultrasonic, heat, or microwave based detectors, as well as mechanical or magnetic switches can also be utilized without departing from the spirit of the present invention.

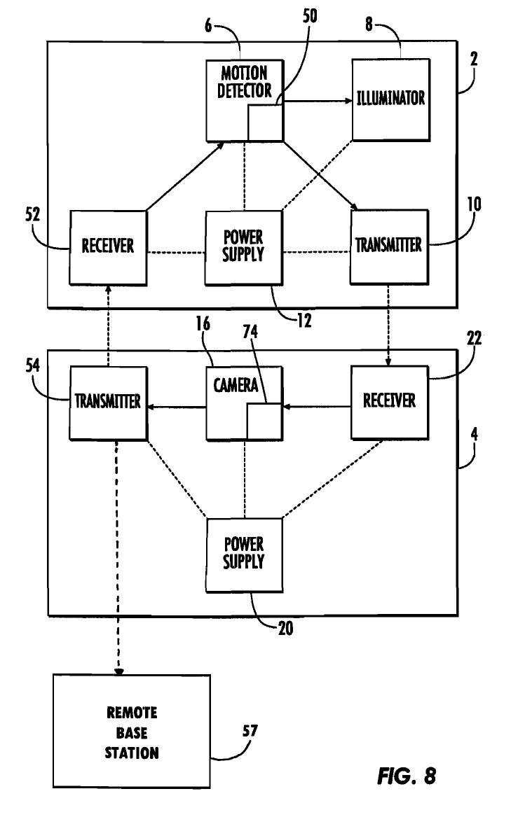

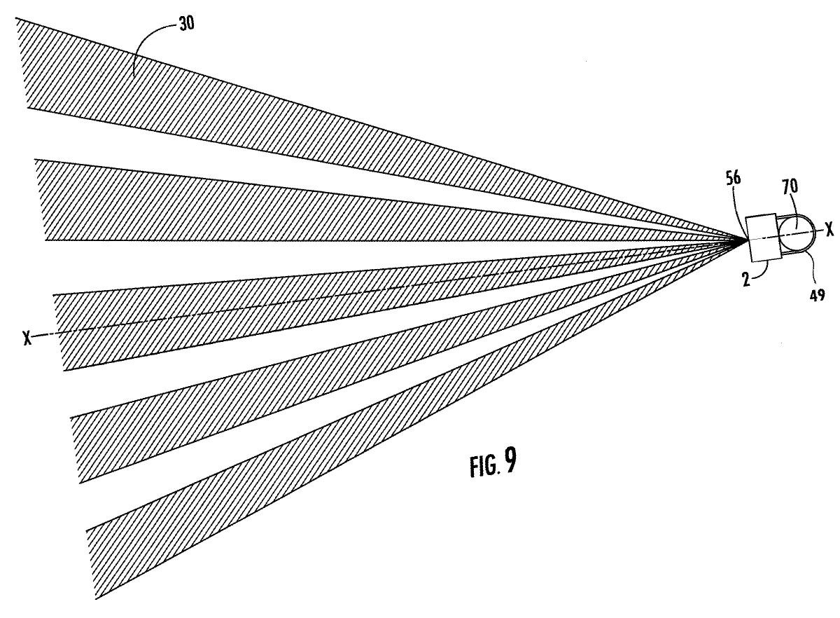

Referring generally to FIGS. 7 and 8, the motion detector 6 also may comprise an integrated control circuit 50 used to activate the illumination device 8 and to instruct the transmitter to transmit an appropriate signal to the remotely located camera 16. This control circuit 50 can be set for day, night, or twenty-four (24) hour operation and includes a choice of time delays and video length for the camera, sensitivity adjustment for the motion detector, event counters, and numerous other features utilized in the control of both motion detectors and digital cameras. In an alternate embodiment, this control circuit 50 may comprise a separate component located within the first housing 2. A similar control circuit could also be utilized in the second housing 4 to control the function of the camera 16. However, any suitable arrangement for the control of the indicated devices can be utilized without departing from the scope of the invention.

In a preferred embodiment, the transmitter 10 is an RF transmitter and the receiver 22 is an RF receiver. The RF transmitter is used to transmit a signal from the control circuit to an RF receiver located in the second housing 4. In a more preferred embodiment shown in FIG. 8, the second housing 4 also includes an RF transmitter 54 and the first housing includes an RF receiver 52 such that two-way communication is provided between the first and second housings. One of ordinary skill in the art would understand that other mechanisms capable of transmitting and receiving signals between two separated components can be used without departing from the spirit of the present invention.

Included in each housing 2, 4 is a power supply 12, 20, used to power the motion detector 6, the illumination device 8, the camera 16, control circuit 50 and the transmitters and/or receivers 10, 22, 52, 54 in addition to any other components contained therein such as indicating lights or LEDs. The power supply 12, 20 preferably comprises a DC power source, such as conventional batteries, but may also utilize other power sources, including solar, AC, or any other suitable supply. In an alternate embodiment, multiple power supplies can be utilized within a given housing to power the various components, such as two distinct sets of batteries in each of the first and second housings 2, 4 for use by the illumination device 8 and motion detector 6, and the camera 16 and receiver 22, 52 respectively.

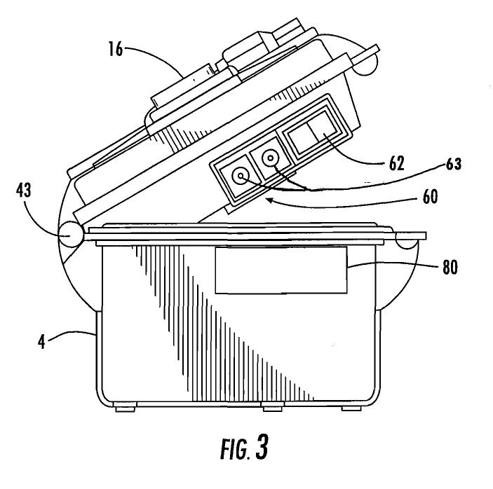

Referring generally to FIG. 7, in a preferred embodiment of the present invention the first housing 2 contains an illumination device 8, a motion detector 6, and a transmitter 10, all receiving power from a first power supply 12. A second housing 4 contains a receiver 22 and a camera 16, both powered by a second power supply 20. When the motion detector 6 is activated, the control circuit 50 initiates the illumination device 8 and instructs the transmitter 10 to transmit a signal to the receiver 22 (via the antenna 41, FIG. 2) which activates the camera 16 to take a predetermined number of pictures, or initiate video recording. Because the camera 16 is placed in the second housing 4, both the first and second housings 2, 4 can be made smaller, and therefore better hidden from view from possible thieves. Further, the separation of the illumination device 8 from the camera 16 ensures that the flash or glow from the illumination device 8 or light front the indicating lights or LEDs will not disclose the camera's location. The functionality of the system is retained despite the relocation of the components as the illumination device 8 remains aimed in the area covered by the motion detector 6 as a result of their location in the same housing.

Referring generally to FIG. 8, the first housing 2 may also include a receiver 52 and the second housing 4 may include a transmitter 54. In this embodiment, two-way communication is provided between the first and second housings 2, 4 via the transmitter 54, antennas 40, 41 (FIGS. 2, 5), and receiver 52. One such benefit of this arrangement is the camera's ability to confirm that a picture or video has been taken by sending an RF signal via the transmitter 52 back to the control circuit 50 by way of the receiver 54 located in the first housing 2. Numerous other uses of this two-way arrangement are envisioned, for example, the remote testing of the components of either housing, communicating battery strength, and transmission of an image or video signals provided by the camera 16 to a display mounted within the first housing 2.

Still referring to FIG. 8, the transmitter 54 in the second housing 4 can optionally transmit pictures or video taken from the camera 16 to a remotely located base station 57. The base station 57 can be a computer, cell phone, PDA, or any other device capable of remotely viewing video or pictures taken from the camera 16. The transmitter 54 can be an RF transmitter, cell phone, PDA, computer, or any other device capable of transferring video or pictures taken from the camera 16. Furthermore, the transmitter 54 can transmit video or pictures taken from the camera 16 to a website address or an e-mail address.

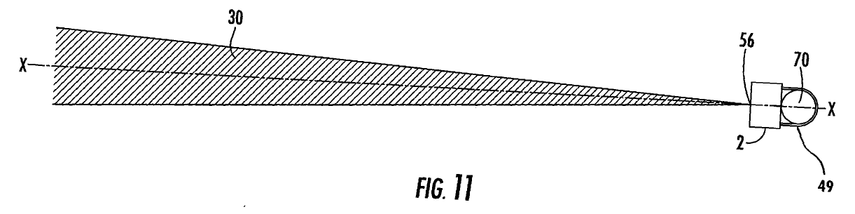

In a preferred embodiment, the motion detector 6 comprises a PIR and utilizes a lens. The lens is preferably a Fresnel lens 56 (FIG. 13) which forms one or more detection zones. FIGS. 9 and 10 illustrate an embodiment of the present invention in which a motion detector 6 uses a Fresnel lens 56 to create five (5) detection zones 30. As shown, the five (5) detection zones 30 can define a plane arranged horizontally with respect to a ground surface A, providing coverage to an area extending outwardly along an axis X-X from the motion detector 6 at a generally fixed height. Although a five (5) zone configuration is shown, any number of detection zones of varying dimensions and configurations may be used to create a desired field of coverage. In order to achieve a detection zone which extends at a height useful for tracking game, the first housing 2 is typically positioned 2-4 feet above the ground. However the first housing may be placed at any desirable height. As shown in FIGS. 9-12, the first housing 2 is securely positioned on a mount 70. The mount 70 can be a tree, post, stand, or any other suitable means, natural or man-made, to which the camera 16 can be securely fastened and appropriately positioned.

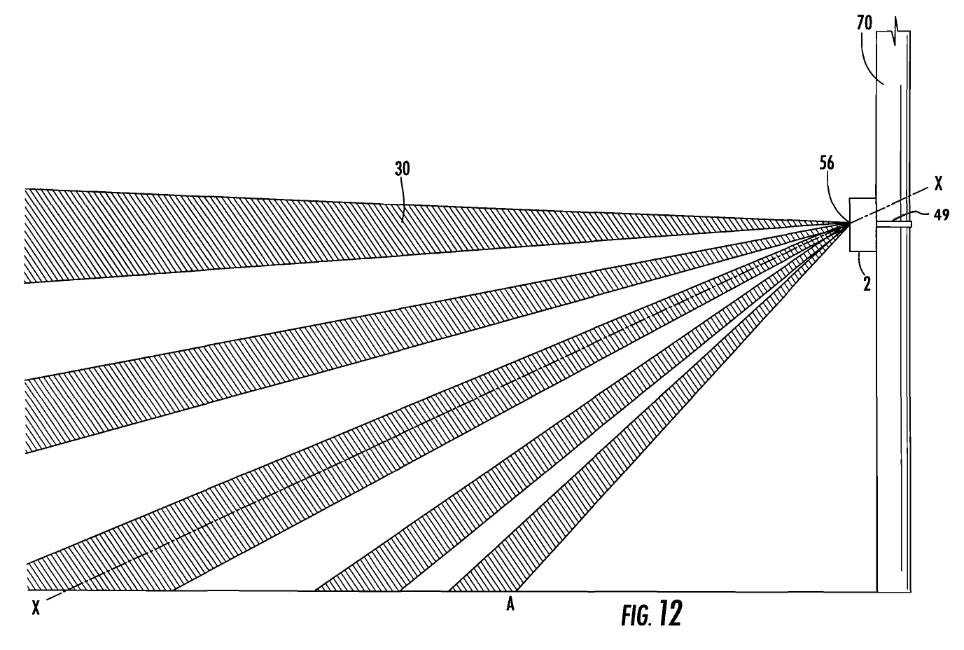

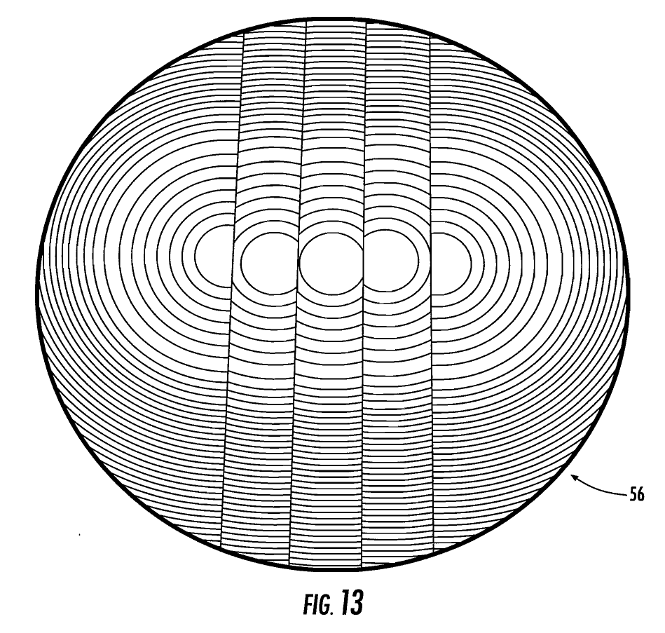

In order to provide more expansive mounting positions of the first housing 2, the motion detector 6 is rotatable or adjustable relative to the first housing 2. As shown in FIGS. 11 and 12, by rotating the detection zones 30 by, for example, 90 degrees about the axis X-X, a generally vertical orientation of the plane defined by the detection zones 30 is achieved. The adjustment of the orientation of the detection zones 30 is not limited to rotation about the axis X-X as described above with respect to FIGS. 11 and 12, but rather, it is envisioned that the detection zones 30 may be adjusted in any direction in order to allow a user to advantageously position the unit in any desired location.

As shown in FIGS. 11 and 12, the vertical orientation of the detection zones 30 allows the first housing 2, including the motion detector 6, to be mounted in an elevated position relative to traditional horizontal arrangements, while maintaining suitable coverage range and area. Thus, the mounting height of the first housing 2 is not dictated by the relative size of the targeted game. Moreover, mounting the first housing 2 higher in, for example, a tree, allows for improved concealment and decreased accessibility, thereby reducing the risk of theft or damage to the unit while in use.

It is envisioned that the orientation of the zones of detection 30 can be accomplished by any suitable means including articulating the lens, the PIR and lens together, or a portion of the housing containing either or both of these elements. The manipulation of the components themselves can also be achieved in a variety of ways. In one embodiment shown in FIG. 5, the lens 56 is located on the front of the housing 2. The lens 56 is rotatably secured to the front of the housing 2 by a frame 42 which is secured to the housing 2 by fasteners 45. At least one gasket 44 may be provided to seal frame 42 and/or the rotatable lens 56 with respect to the housing 2, ensuring that the watertight nature of the housing 2 remains intact. It is envisioned that any number of means could be used to secure the frame 42 to the housing 2 and to ensure the water-tight seal is maintained.

In another embodiment shown in FIG. 6, a portion of the first housing 2 containing the motion detector 6 and/or the illuminator 8 may be hingedly attached, or attached by a swivel-type connection 48 to a remaining portion of the first housing 2. Because the illuminator 8 and the motion detector 6 are movable together, this arrangement ensures that the illuminator 8 remains aimed at the coverage area provided by the motion detector 6. One of ordinary skill in the art would recognize the numerous ways in which any of the components of the motion detector 6 could be movably connected to the first housing 2 in order to achieve the desired adjustability with respect to the orientation of the detection zones 30. Also show in FIG. 6, the housing 2 may further include a movable cover 47. The cover 47 may be used provide selective access to user controls, or to the lens 56, thus allowing for its rotation or adjustment.

In addition to being manually adjustable by the user, it is further envisioned that one or more of the components could be manipulated by, for example, an electric motor such as a stepper or a servo motor. Such an arrangement could be controlled by the above-described RF transmitter and receiver arrangements, thus allowing for remote adjustment of the orientation of the detection zones.

In yet another embodiment of the present invention, multiple cameras can be triggered by one or more motion detector/illumination units or multiple motion detector/illumination units can be used to trigger one or more cameras. The controller 50 can also allow for choice of frequency of each piece so that the units can operate on the same frequency for multiple operation or different frequencies for single operation. Alternatively, a separate controller may be utilized to achieve this function. This choice of frequency, or variations in sub-codes within a frequency, can be controlled in any number of ways including simple switches, dual in-line package (DIP) switches, as well as through an interface integrated into the LCD display. In addition, upon receiving a signal from one of the multiple motion detector/illumination units, the camera 16 can automatically turn to position itself to capture the image or video in the area covered by the particular motion detector/illumination units that transmitted the signal. In this manner, the camera 116 can cover multiple fields of coverage.

The system could also incorporate a hand held remote so that the user can start and stop the video, or tell the camera to take a still picture on command. The remote can have two-way communication with the PIR/illuminator unit and/or the camera. Thus, the remote can be used to program the settings of the PIR/illuminator and check the number of pictures taken, or the duration of video that has been recorded.

In yet another embodiment, the first housing 2 may comprise only a passive motion detector with a daylight sensor, a power supply, and a transmitter to signal the remotely located camera and thus eliminate the need for an illuminator. Such a system, which has maximized potential during daylight hours, has the ability to be arranged at much greater distances from the camera than would be practical at night.

It is envisioned that other embodiments could utilize both a receiver and a transmitter in both the first and second housings 2, 4. A test button on the motion detector could be utilized so that a user can verify that the camera is within range of the transmission. A receiver could also be placed in the hand held remote control allowing the user to verify the functionality of the various components, such as an indicator that the camera is recording. As in existing systems, audio recording, external plugs for connecting auxiliary illuminators, daylight sensors for choosing day, night/, or twenty-four hour operation modes, and numerous other known feature could be incorporated into the present invention without departing from it's intended scope.

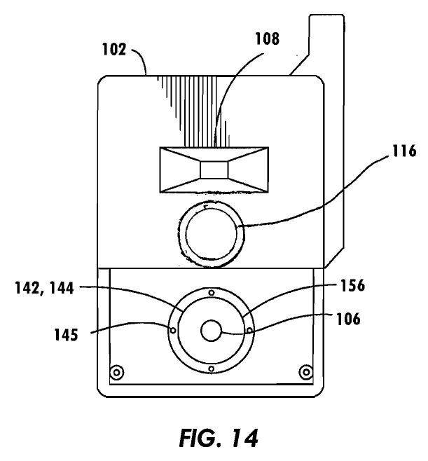

In another embodiment shown in FIG. 14, the camera 116, illumination device 108, and motion detector 106, having an adjustable lens 156 may be included into a single housing unit 102. The field of coverage provided or monitored by the motion detector 106 may be adjusted as described above with respect to the previous embodiments of the present invention. For example, the lens 156 may be a Fresnel lens rotatably secured to the housing by a frame 142 and utilize the same gasket(s) 144 and fasteners 145 as described above with respect to FIG. 5. Likewise, the other variations described above with respect to altering the orientation of the detection zones may also be utilized without departing from the scope of the present invention.

Having thus described in detail several embodiments the present invention, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed:

1. A motion detecting camera system comprising:
a first housing comprising a motion detector, an illuminator, a transmitter, and a first power supply supplying power to the motion detector, the illuminator, and the transmitter, the motion detector providing a field of coverage for detecting motion, the transmitter connected to the motion detector; and
a second housing comprising a camera, a receiver, and a second power supply supplying power to the camera and the receiver, the camera connected to the receiver;
wherein the transmitter transmits a signal to the receiver to instruct the camera to record an image when the motion detector detects apparent motion within the field of coverage.

2. The motion detecting camera system of claim 1, wherein the camera records an image onto a memory device.

3. The motion detecting camera system of claim 1, wherein the field of coverage is defined by a plurality of detection zones.

4. The motion detecting camera system of claim 3, wherein the camera is arranged to record an image located at least partially within at least one detection zone.

5. The motion detecting camera system of claim 1, wherein the motion detector activates the illuminator when apparent motion is detected within the field of coverage.

6. The motion detecting camera system of claim 1, wherein the motion detector is selected from the group consisting of an infrared detector, a light detector, an ultrasonic detector, a microwave detector, a heat detector, a magnetic detector, and a mechanical detector.

7. The motion detecting camera system of claim 6, wherein the wherein the motion detector comprises a Fresnel lens, the Fresnel lens providing a plurality of detection zones.

8. The motion detecting camera system of claim 1, wherein the wherein the motion detector comprises a Fresnel lens, the Fresnel lens providing a plurality of detection zones.

9. The motion detecting camera system of claim 8, wherein the motion detector is adjustable with respect to the first housing to adjust the orientation of the plurality of detection zones.

10. The motion detecting camera system of claim 8, wherein the plurality of detection zones are arranged along a plane which is oriented substantially parallel to the ground surface.

11. The motion detecting camera system of claim 10, wherein the motion detector is rotatable to adjust the plane of orientation of the plurality of detection zones to be substantially perpendicular to the ground surface.

12. The motion detecting camera system of claim 8, wherein the wherein the Fresnel lens is adjustable with respect to the first housing to adjust the orientation of the plurality of detection zones.

13. The motion detecting camera system of claim 1, wherein the motion detector is adjustable with respect to the first housing to adjust the orientation of the field of coverage.

14. The motion detecting camera system of claim 1, wherein at least a portion of the motion detector is movably attached to the first housing.

15. The motion detecting camera system of claim 1, wherein the motion detector comprises a motion sensor and a focusing lens;
wherein at least one of the focusing lens and the motion sensor are movably mounted to the first housing.

16. The motion detecting camera system of claim 15, wherein the motion sensor comprises a passive infrared sensor (PIR).

17. The motion detecting camera system of claim 1, further comprising a remote control unit capable of controlling at least one selected from the group consisting of the camera, the motion detector, and the illuminator.

18. The motion detecting camera system of claim 17, wherein the motion detector is adjustable with respect to the first housing to adjust the orientation of the field of coverage and the remote control unit is capable of remotely adjusting the motion detector.

19. The motion detecting camera system of claim 1, wherein the transmitter is an RF transmitter and the receiver is an RF receiver.

20. The motion detecting camera system of claim 19, wherein the first housing further comprises an RF receiver and the second housing further comprises an RF transmitter;
wherein the RF transmitter in the second housing transmits a signal to the RF receiver in the first housing when the camera records an image.

21. The motion detecting camera system of claim 1, wherein the motion detector comprises a controller to activate the illumination device and the camera.

22. The motion detecting camera system of claim 1, wherein the second housing further comprises a transmitter to transmit images recorded by the camera to a remote base station.

23. A method for using a motion detecting camera system comprising:
providing a first housing comprising a motion detector, an illuminator, a transmitter, and a first power supply supplying power to the motion detector, the illuminator, and the transmitter, the motion detector providing a field of coverage for detecting motion, the transmitter and the illuminator connected to the motion detector;
providing a second housing comprising a camera, a receiver, and a second power supply supplying power to the camera and the receiver, the camera connected to the receiver; and
transmitting a signal from the transmitter to the receiver to instruct the camera to record an image when the motion detector detects apparent motion within the field of coverage.

24. The method of claim 23, wherein the first and second housings are positioned in remote locations from one another.

25. The method of claim 23, wherein the motion detector activates the illuminator when apparent motion is detected within the field of coverage.

26. A motion detecting camera system comprising:
a housing comprising a camera, a motion detector, an illuminator, and power supply supplying power to the camera, motion detector, and the illuminator,
the motion detector providing a field of coverage for detecting motion and the camera recording an image when the motion detector detects apparent motion within the field of coverage,
wherein the motion detector comprises an adjustable Fresnel lens providing a plurality of detection zones, the Fresnel lens is adjustable with respect to the housing to adjust the orientation of the detection zones.
